(19) United States
(12) Patent Application Publication
(10) Pub. No.: US 2007/0212435 A1
(43) Pub. Date: Sep. 13, 2007

(54) TIRE MOLD

(75) Inventor: Nobuyuki KAMADA, Osaka-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOYO TIRE & RUBBER CO., LTD., Osaka (JP)

(21) Appl. No.: 11/683,066

(22) Filed: Mar. 7, 2007

(30) Foreign Application Priority Data
Mar. 8, 2006 (JP) 2006-062699
Dec. 25, 2006 (JP) 2006-347854

(51) Int. Cl. B29D 29/00

(52) U.S. Cl. 425/46; 425/28.1

(57) ABSTRACT

A tire mold is for vulcanization molding of a tire. The mold comprises a sector with which a tread surface of the tire is brought into contact. A first uneven surface for forming a tread pattern is provided at the contact position. A lower die with which a side wall portion of the tire is brought into contact has a second uneven surface for forming a pattern design continuously with the tread pattern. There is a sector moving mechanism that moves the sector in a tire width direction and a tire diametrical direction. There is also a mechanism for engaging the sector and the lower die in a mold clamp state.

### BACKGROUND OF THE INVENTION

1. Field of the Invention

The present invention relates to a tire mold for vulcanization molding a tire.

2. Description of the Related Art

A tire mold for vulcanization molding a tire is structured by combining a plurality of die portions, and is broadly divided into a 2-piece mold and a segmented mold on the basis of its divided aspect. The 2-piece mold is provided with a lower die 31 and an upper die 32 brought into contact with a side wall portion of the tire, as shown in FIG. 14, and is structured such that each of them is brought into contact with a tread surface Tr1 of a tire T1 approximately half and half. In this case, the tire T1 is closely attached to an inner peripheral surface of the tire mold by expanding a bladder (not shown) arranged in an inner peripheral side thereof.

On the other hand, the segmented mold is provided with a sector 43 brought into contact with a tread surface Tr2 in addition to a lower die 41 and an upper die 42 brought into contact with a side wall portion SW of a tire T2, as shown in FIG. 15. The upper die 42 and the sector 43 which are in a mold open state come down so as to come close to the lower die 41 in which a green tire is set, and the sector 43 is moved to an inner side in a tire diametrical direction to achieve a mold clamp state. In this case, the sector 43 is divided into a plurality of sections in a peripheral direction, and they are spaced radially in the mold open state, and get together with each other in the mold clamp state to form an annular shape.

The tire mold is provided with a uneven surface at a position with which the tread surface of the tire is brought into contact, whereby various tread patterns are formed. Further, in the case that a pattern design is formed also in the side wall portion such as a pneumatic tire described in Japanese Patent Application Laid-open No. H11-291718, Japanese Patent Application Laid-open No. H8-197917, and Japanese Patent Application Laid-open No. 2000-16031, it is necessary to set the uneven surface at a position with which the side wall portion of the tire is brought into contact.

However, in the segmented mold, since boundaries between the sector and the upper and lower dies are arranged near a shoulder portion of the tire, the following problems are generated. In other words, the lower die is fixed in a state of setting a certain degree of play in the peripheral direction in such a manner that the green tire can be smoothly set, however, if the lower die generates a displacement in the peripheral direction with respect to the sector, at a time of molding the tire in which a pattern design is continuously provided from the tread surface to the side wall portion as described in Japanese Patent Application Laid-open No. H11-291718, there is a problem that the pattern design is deviated in the peripheral direction at the boundaries.

There is a case that an amount of displacement comes to about 7 mm in the displacement in the peripheral direction mentioned above, however, the displacement can not be recognized in a state in which the tier mold is clamped, but can be only recognized in an ex-post manner by the vulcanized tire. In this case, in a pneumatic tire in which a groove extending in a peripheral direction is provided between the tread surface and the side wall portion, and a pattern design is discontinuously formed, such as a pneumatic tire described in Japanese Patent Application Laid-open No. H8-197917 and Japanese Patent Application Laid-open No. 2000-16031, the problem mentioned above can be avoided by arranging a boundary between the sector and the lower die at the position in which the groove is formed.

### SUMMARY OF THE INVENTION

An object of the present invention is to provide a tire mold for vulcanization molding a tire in which a pattern design is continuously formed from a tread surface to a side wall portion, in which the tire mold can prevent a displacement in a peripheral direction between a sector and a lower die, and can suitably form the pattern design.

The object can be achieved by the present invention having the following structure. That is, the present invention provides a tire mold for vulcanization molding a tire comprising: a sector with which a tread surface of a tire is brought into contact, and in which a first uneven surface for forming a tread pattern is provided at the contact position; a lower die with which a side wall portion of the tire is brought into contact, and in which a second uneven surface for forming a pattern design continuously provided with the tread pattern is provided at the contact position so as to be continuously provided with the first uneven surface in a mold clamp state; a sector moving mechanism moving the sector in a tire width direction and a tire diametrical direction; and engaging means for engaging with each other between the sector and the lower die which are in the mold clamp state, and positioning the sector and the lower die relatively in a peripheral direction.

A tire mold in accordance with the present invention is constituted by a segmented mold provided with a sector with which a tread surface of a tire is brought into contact, and a lower die with which a side wall portion is brought into contact. The sector is provided with a first uneven surface for forming a tread pattern, and the lower die is provided with a second uneven surface for forming a pattern design continuously provided with the tread pattern. Accordingly, it is possible to vulcanization form the tire in which the pattern design is continuously provided from the tread surface to the side wall portion.

Further, it is possible to move the sector between a position which is spaced from the lower die in the mold open state, and a position which is close to the lower die in the mold clamp state, by setting a sector moving mechanism moving the sector in a tire width direction and a tire diametrical direction. Further, it is possible to prevent a displacement in the peripheral direction between the sector and the lower die in the mold clamp state, by setting engaging means for engaging with each other between the sector and the lower die in the mold clamp state, and relatively positioning the sector and the lower die in the peripheral direction. As a result, it is possible to well form the pattern design continuously provided from the tread surface to the side wall portion without generating the displacement in the peripheral direction, by suitably continuously forming the first uneven surface and the second uneven surface in the mold clamp state.

In the structure mentioned above, it is preferable that the engaging means are constituted by an engagement pin protruding to the lower die side from the sector, and a fitting groove provided in the lower die so as to extend along the tire diametrical direction and to which the engagement pin is freely fitted, and a groove width of the fitting groove being reduced little by little toward an inner side in the tire diametrical direction. In accordance with the structure mentioned above, the engaging pin is fitted to the fitting groove in the process of changing from the mold open state to the mold clamp state, and the relative position between the sector and the lower die is adjusted by the movement of the engaging pin to the inner side of the tire diametrical direction, whereby it is possible to position both the elements relatively in the peripheral direction.

In the structure mentioned above, it is preferable that the engaging means have an engagement convex portion provided in one of the sector and the lower die, and an engagement concave portion provided in the other of the sector and the lower die, and are structured such that the engagement convex portion and the engagement concave portion are engaged little by little by moving the sector close to the lower die along the tire diametrical direction. In accordance with the structure mentioned above, the engagement convex portion and the engagement concave portion are engaged little by little by moving the sector close to the lower die along the tire diametrical direction in the process of changing from the mold open state to the mold clamp state, whereby it is possible to relatively position the sector and the lower die in the peripheral direction.

In the structure mentioned above, it is preferable that the engagement convex portion provided in the sector has a first taper surface narrowed toward an inner side in the tire diametrical direction, and the engagement concave portion provided in the lower die has a second taper surface narrowed toward the inner side in the tire diametrical direction, and the first taper surface and the second taper surface are engaged with each other in the mold clamp state.

In accordance with the structure mentioned above, since the engagement convex portion and the engagement concave portion have the taper surfaces which are respectively narrowed toward the inner side in the tire diametrical direction, and they are engaged with each other in the mold clamp state, it is possible to preferably regulate both of the displacement in the peripheral direction and an angular deviation between the sector and the lower die. As a result, it is possible to adjust the relative position between the sector and the lower die little by little and at a high precision, thereby forming the pattern design more suitably, and it is possible to increase a complete roundness of the sectors arranged in the peripheral direction, thereby improving a uniformity of the formed tire.

In the structure described above, it is preferable that the engagement convex portion is integrally cast with the sector. In accordance with the structure mentioned above, it is possible to increase a durability of the engagement convex portion so as to improve a maintenance characteristic, and it is possible to omit an additional step for setting the engagement convex portion in the sector.

### BRIEF DESCRIPTION OF THE DRAWINGS

FIG. 1 is a vertical cross sectional view for schematically showing a tire mold in accordance with a first embodiment of the present invention;

FIG. 2 is a plan view of a sector provided in the tire mold;

FIG. 3 is a plan view for showing a portion near a boundary between the sector and a lower die in an enlarged manner;

FIG. 4 is an enlarged view for showing a portion near a lower side of the sector in a mold clamp state;

FIG. 5 is a cross sectional view as seen from an arrow C-C in FIG. 4;

FIG. 6 is a view for explaining an opening and closing operation of the tire mold;

FIG. 7 is a view for explaining the opening and closing operation of the tire mold;

FIG. 8 is a view explaining the opening and closing operation of the tire mold;

FIG. 9 is a vertical cross sectional view for schematically showing a tire mold in accordance with a second embodiment of the present invention;

FIG. 10 is an enlarged view for showing a portion near a lower side of a sector in a mold clamp state;

FIG. 11 is a plan view for showing an engagement concave portion.

FIG. 12 is a cross sectional view as seen from an arrow D-D in FIG. 10;

FIG. 13 is a plan view for explaining a movement of the sector;

FIG. 14 is a view of an outline structure of a 2-piece mold; and

FIG. 15 is a view of an outline structure of a segmented mold.

### DETAILED DESCRIPTION OF THE PREFERRED EMBODIMENTS

Embodiments of the present invention will be explained with reference to the drawings.

### First Embodiment

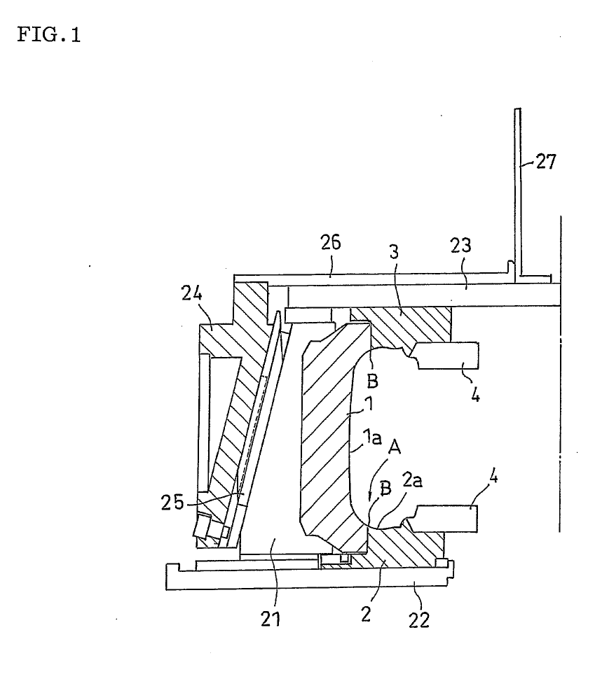

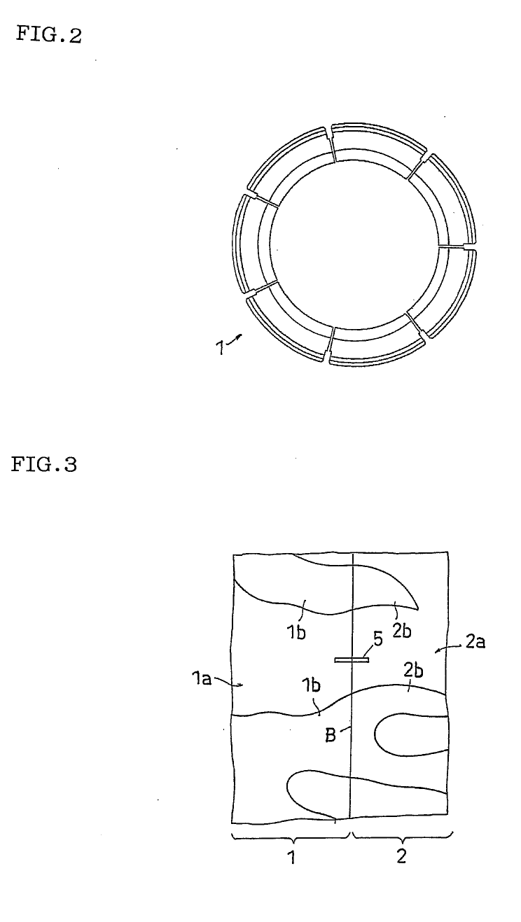

FIG. 1 is a vertical cross sectional view for schematically showing a tire mold in accordance with a first embodiment of the present invention, and shows a mold clamp state. In the drawing, a green tire (not shown) is set in such a manner that a tire axial direction forms upper and lower sides. In other words, a vertical direction in FIG. 1 corresponds to a tire width direction, a rightward direction corresponds to an inner side in a tire diametrical direction, and a leftward direction corresponds to an outer side in the tire diametrical direction. FIG. 2 is a plan view of a sector provided in the tire mold.

The tire mold is constituted by a segmented mold provided with a sector 1 with which a tread surface of a tire is brought into contact, a lower die 2 with which a lower side wall portion is brought into contact, and an upper die 3 with which an upper side wall portion is brought into contact.

As a raw material of the sector 1, aluminum is exemplified. The aluminum is a concept including an aluminum alloy in addition to a pure aluminum raw material, and there can be listed up, for example, Al—Cu, Al—Mg, Al—Mg—Si, Al—Zn—Mg, Al—Mn and Al—Si. Further, as a raw material of the lower die 2 and the upper die 3, a steel material is exemplified.

The sector 1 is divided into a plurality of sections (for example, seven or eleven sections) in a peripheral direction, and these sections get together in a mold clamp state to form an annular shape. FIG. 2 shows an example in which lengths in the peripheral direction of the sectors 1 are approximately uniform, however, the present invention is not limited to this, and a dividing number of the sector 1 is not particularly limited. Boundaries B between the sector 1 and the upper and lower dies 2, 3 extend vertically, and are arranged near a shoulder portion of the tire. A bead ring 4 is provided in inner sides in the tire diametrical direction of the upper and lower dies 2, 3, and is structured such that a bead core of the tire can be fitted.

A first uneven surface 1a for forming a tread pattern is provided at a position of the sector 1 which is brought into contact with a tread surface. In other words, the tread surface of a pneumatic tire is provided with a groove portion such as a peripheral groove, a lateral groove or the like, and a land portion such as a block, a rib or the like sectioned by the groove portion, in correspondence to a required tire performance and working condition, however, the first uneven surface 1a is provided with a convex portion forming the groove portion and a concave portion forming the land portion.

FIG. 3 is a plan view for showing a portion near the boundary portion B between the sector 1 and the lower die 2 in an enlarged manner, and corresponds to a view as seen from an arrow A in FIG. 1. A second uneven surface 2a for forming a pattern design continuously provided with the tread pattern is provided at a position of the lower die 2 with which the side wall portion is brought into contact, and is connected to the first uneven surface 1a in the mold clamp state. In more detail, a concave portion 2b of the second uneven surface 2a extends continuously with the concave portion 1b of the first uneven surface 1a, whereby a block extended from the tread portion to the side wall portion is formed. As mentioned above, since the tire mold in accordance with the present invention is structured such that the pattern design of the side wall portion is continuously provided with the tread pattern, there is required a structure in which a displacement is not generated in the peripheral direction of the sector 1 and the lower die 2 in the mold clamp state.

In the case that the groove extending in the peripheral direction is provided between the tread surface and the side wall portion, such as the pneumatic tires described in Japanese Patent Application Laid-open No. H8-197917, and Japanese Patent Application Laid-open No. 2000-16031 as be mentioned above, the annular rib is provided along the boundary B between the sector 1 and the lower die 2. In this case, since the pattern design formed in the side wall and the tread pattern portion become discontinuous, the displacement in the peripheral direction of the pattern design does not become a question even if the lower die 2 generates a displacement in the peripheral direction with respect to the sector 1.

In the present embodiment, a saw cut 5 cutting across the boundary B is provided in the first uneven surface 1a and the second uneven surface 2a. This element is provided for visibly recognizing the displacement in the peripheral direction between the sector 1 and the lower die 2, with respect to the vulcanization formed tire. In the present embodiment, a uneven surface continuously provided with the first uneven surface 1a is provided in the same manner as the lower die 2, at a position of the upper die 3 with which the side wall portion is brought into contact.

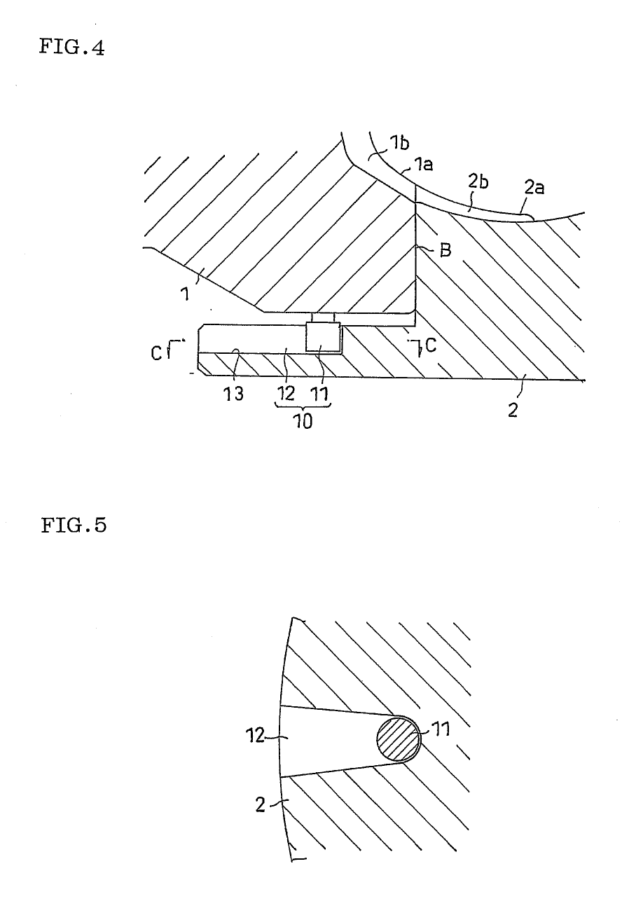

FIG. 4 is an enlarged view for showing a portion near a lower side of the sector 1 in a mold clamp state. The tire mold is provided with engaging means 10 for engaging with each other between the sector 1 and the lower die 2 in the mold clamp state, in specific, is provided with an engagement pin 11 protruding to a lower side from the sector 1, and a fitting groove 12 extended in the lower die 2 along the tire diametrical direction and to which the engagement pin 11 can be fitted. A groove width of the fitting groove 12 is reduced little by little toward an inner side in the tire diametrical direction as shown in FIG. 5, and is set so as to be approximately the same dimension as that of a head portion of the engagement pin 11 in an inner end in the tire diametrical direction.

The engagement pin 11 can be structured comparatively inexpensive by utilizing a normal knock pin. Further, the fitting groove 12 is not limited to the structure having a bottom portion 13 such as the present embodiment, but may be constituted by a groove having no bottom portion.

As shown in FIG. 1, the sector 1 is attached to a side surface of a container 21, the lower die 2 is attached to an upper surface of a plate-like container 22, and the upper die 3 is attached to a lower surface of a plate-like container 23, respectively, and the tire mold is opened and closed on the basis of the movement of each of the containers. The lower die 2 is fixed to the container 22 with a play of some millimeter unit in the peripheral direction in such a manner that the green tire can be smoothly set. On the contrary, the play mentioned above is not provided in the upper die 3, and the upper die 3 is firmly fixed to the container 23 in a state of being positioned precisely with respect to the sector 1. Further, the container 23 is structured such as to freely ascend and descend, and can move the upper die 3 between a position which is spaced from the tire in the mold open state and a position which is close to the tire in the mold clamp state.

The container 21 to which the sector 1 is attached is attached to the lower surface of the container 23 slidably along the tire diametrical direction, and the sector 1 ascends and descends together with the upper die 3. In a side surface in an opposite side to a side of the container 21 to which the sector 1 is attached, there is provided a slidable rail 25 which is inclined to an outer side in the tire diametrical direction toward a lower side, and a container 24 is arranged in an outer side in the tire diametrical direction. As mentioned above, the sector 1 is divided into a plurality of sections in the peripheral direction, and the container 21 is provided per the divided sector 1.

The container 24 is supported to an arm 26 extending horizontally from an upper portion thereof. The arm 26 is attached to a guide plate 27 provided vertically in an upper surface of the container 23 so as to freely ascend and descend, and the container 24 is structured such as to freely ascend and descend relatively with respect to the container 23. Further, a side surface of the container 24 in the sector 1 side is fitted to the slidable rail 25, and the container 24 and the container 21 are structured slidably along the inclined direction of the side surface. Accordingly, it is possible to move the container 21 to the inner side in the tire diametrical direction by descending the container 24, and the container 21, the container 23 and the container 24 construct the sector moving mechanism in the present embodiment.

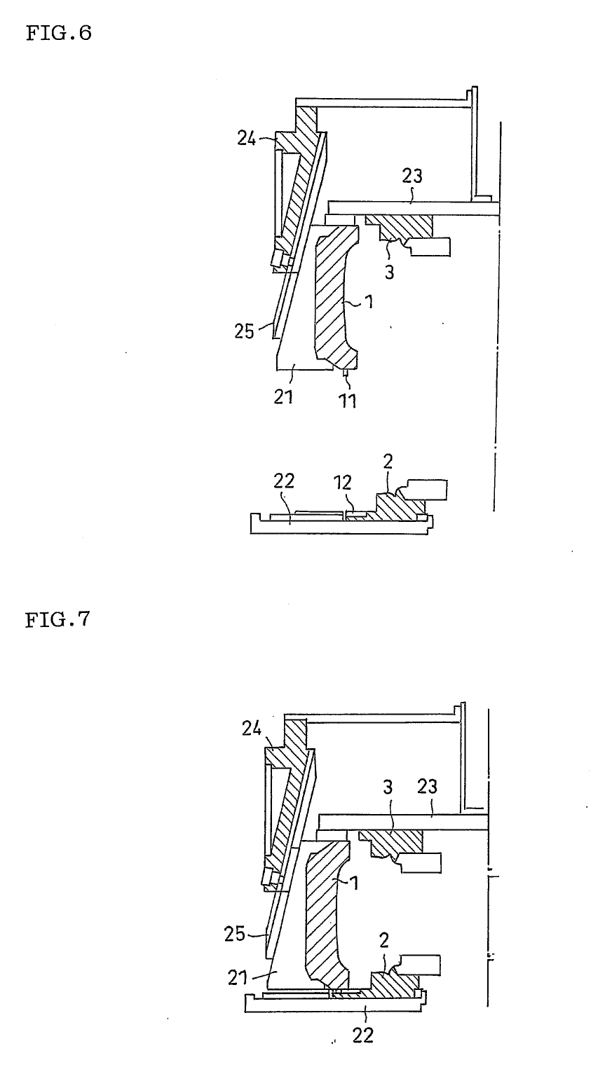

FIGS. 6 to 8 are views for explaining an opening and closing motion of the tire mold, and show a process changing to the mold clamp state shown in FIG. 1 from the mold open state. FIG. 6 shows a state in which the sector 1 and the upper die 3 are spaced from the lower die 2 to the upper side, and the green tire can be set to the lower die 2. If the container 23 is moved downward from this state, the upper die 3 reaches the position brought into contact with the side wall portion of the tire as shown in FIG. 7, and the sector 1 is arranged in the outer side in the tire diametrical direction of the tread surface.

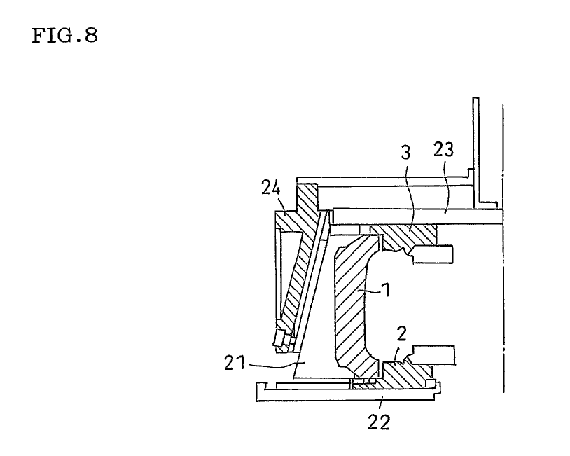

Subsequently, if the container 24 is moved downward, the container 21 is moved to the inner side in the tire diametrical direction as shown in FIG. 8, and the mold clamp state as shown in FIG. 1 is achieved. In the process of changing to the mold clamp state from the mold open state, the engagement pin 11 is fitted to the fitting groove 12, the lower die 2 is guided by the engagement pin 11 moving to the inner side in the tire diametrical direction, and the fitting groove 12 and the engagement pin 11 are engaged in the peripheral direction to be positioned. As a result, it is possible to prevent the displacement between the sector 1 and the lower die 2 in the peripheral direction, and it is possible to well form the pattern design continuously provided with the side wall portion from the tread surface, by suitably connecting the first uneven surface 1a and the second uneven surface 2a.

In the present embodiment, the engagement pin 11 is fitted to the fitting groove 12 at the stage that the sector 1 is arranged in the outer side in the tire diametrical direction of the tread surface (refer to FIG. 7), however, the present invention is not limited to this, but may be structured such that the engagement pin 11 is fitted to the fitting groove 12 at a time when the sector 1 moves to the inner side in the tire diametrical direction.

In the tire mold in accordance with the present invention, the shape and the material of the sector 1 and the upper and lower dies 2 and 3, the mechanical of each of the containers and the like are not particularly limited, and the shapes of the first uneven surface 1a and the second uneven surface 2a are not particularly limited as far as they are provided continuously in the mold clamp state. For example, the embodiment mentioned above is structured such that the sector 1 is moved horizontally to be brought into contact with the tread surface, however, may be structured such that the sector is moved in the tire diametrical direction while descending, that is, is moved obliquely to be brought into contact with the tread surface. In the case mentioned above, the bottom portion of the fitting groove may be formed in the taper shape in corresponding to the engagement pin moving obliquely so as to be guided. In this case, the engaging means 10 may be provided in at least one of the sectors divided in the peripheral direction.

In the embodiment mentioned above, there is shown the example in which the lower die 2 is attached to the container 22 in the state in which the play is provided in the peripheral direction, however, the present invention is not limited to this. For example, the lower die 2 may be fixed to the container 22 so as not to move in the peripheral direction, and the sector 1 may be fixed to the container 21 in a state in which a play is provided in the peripheral direction. Even in the case mentioned above, the same effect as mentioned above can be obtained.

### EXAMPLE

The engaging means constituted by the engagement pin and the fitting groove as shown in the embodiment mentioned above is provided in the tire mold for vulcanization molding the pneumatic tire having the tire size 305/40R22. A pin diameter of the head portion of the engagement pin is set to 12 mm, a groove width in an outer side in the tire diametrical direction of the fitting groove is set to 13 mm, a groove width in an inner side thereof is set to 12.5 mm, and a working tolerance is set to ±0.2 mm. As a result, a displacement in the peripheral direction generated in the pattern design is 0.5 mm at the maximum in the case of molding 1000 tires.

In the result of the case that the pin diameter mentioned above is differentiated in 1 mm unit between 10 and 16 mm, the groove width in the outer side in the tire diametrical direction is set to pin diameter+1 mm, the groove width in the inner side thereof is set to pin diameter+0.5 mm, and the working tolerance is set to ±0.2 mm, the displacement in the peripheral direction generated in the pattern design is within the range between 0.1 and 1 mm, and an outer appearance of the pattern design is not largely deteriorated. As mentioned above, it is possible to prevent the displacement in the peripheral direction between the sector and the lower die, and it is possible to well form the pattern design which is continuously provided from the tread surface to the side wall portion, on the basis of the provision of the engaging means in the tire mold.

### Second Embodiment

Since a second embodiment has the same structure and operation as those of the first embodiment except the following structures of the engaging means and the like, a description will be given mainly of different points by omitting the common points. In this case, the same reference numerals are attached to the same members and positions as the already described members and positions in the description of the first embodiment, and an overlapping description will be omitted.

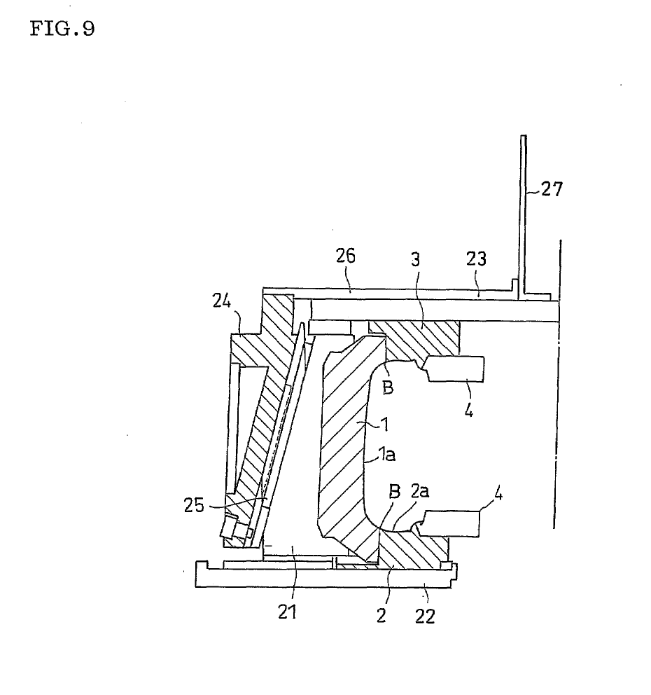

FIG. 9 is a vertical cross sectional view for schematically showing a tire mold in accordance with a second embodiment of the present invention. In the present embodiment, the lower die 2 is fixed to the container 22 so as not to move in the peripheral direction, and the sector 1 is attached to the container 21 in a state in which a play in millimeters is provided in the peripheral direction and the tire diametrical direction. Further, the upper die 3 is firmly fixed to the container 23 in a state of being precisely positioned to the lower die 2.

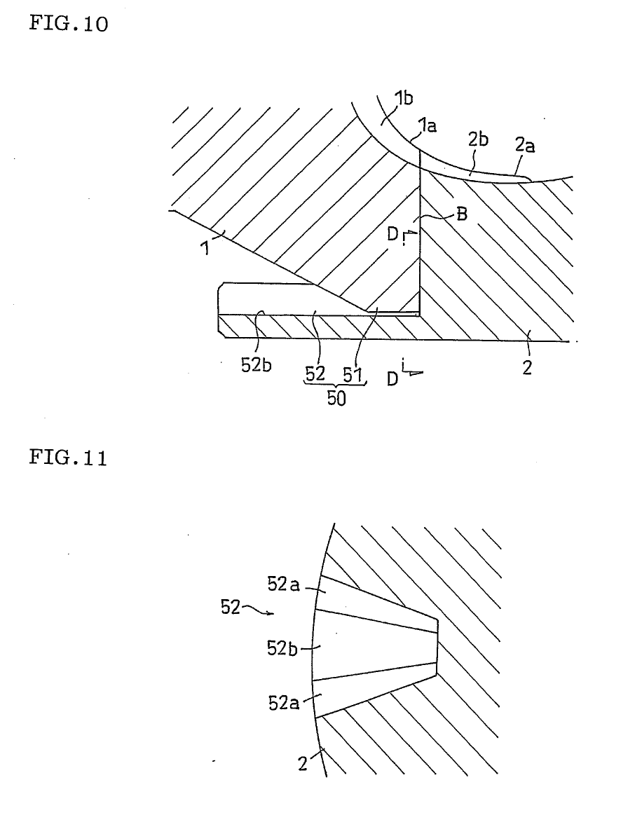

FIG. 10 is an enlarged view for showing a portion near the lower side of the sector 1 in the mold clamp state. The tire mold is provided with engaging means 50 which are engaged with each other between the sector 1 and the lower die 2 in the mold clamp state. The engaging means 50 has an engagement convex portion 51 protruding downward from the sector 1, and an engagement concave portion 52 open toward an upper side from the lower die 2.

FIG. 11 is a plan view of the engagement concave portion 52, and FIG. 12 is a cross sectional view as seen from an arrow D-D in FIG. 11. The engagement concave portion 52 has a pair of taper surfaces 52a (corresponding to the second taper surface) which become narrowed toward an inner side in the tire diametrical direction (a right side in FIG. 11) and an outer side in the tire width direction (a lower side in FIG. 12), and a trapezoidal bottom portion 52b. Further, the engagement convex portion 51 has a pair of taper surfaces 51a (corresponding to the first taper surface) which become narrowed toward the inner side in the tire diametrical direction and the outer side in the tire width direction, and a trapezoidal top portion 51b, and a shape and a size thereof correspond to the engagement concave portion 52.

The engagement convex portion 51 and the engagement concave portion 52 are structured such as to be engaged with each other in the process of changing from the mold open state to the mold clamp state, such as the engagement pin 11 and the fitting groove 12 in the first embodiment. Further, in the opening and closing motion as shown in FIGS. 6 to 8, if the sector 1 comes close to the lower die 2 along the tire diametrical direction, an interval between the taper surface 52a of the engagement concave portion 52 and the taper surface 51a of the engagement convex portion 51 fitted to the engagement concave portion 52 becomes small. Accordingly, the engagement convex portion 51 and the engagement concave portion 52 are engaged little by little, and the taper surface 51a and the taper surface 52a are engaged with each other in the mold clamp state.

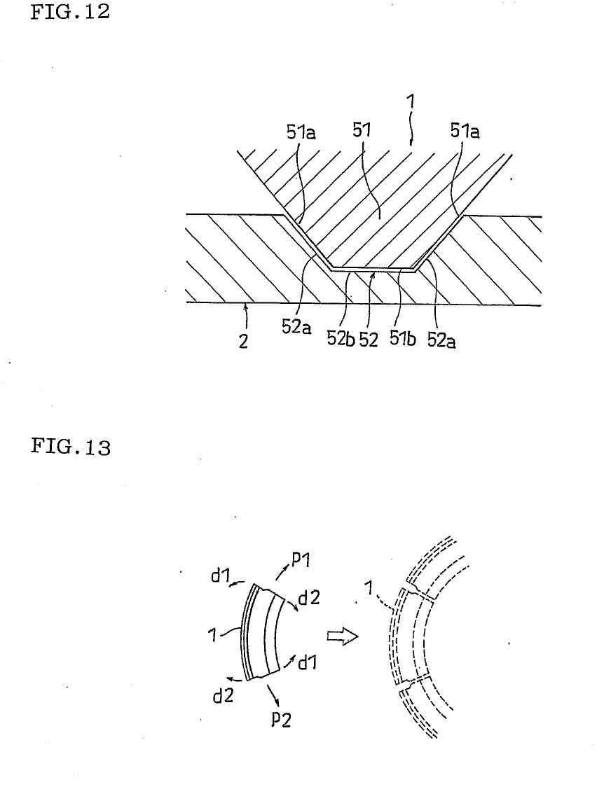

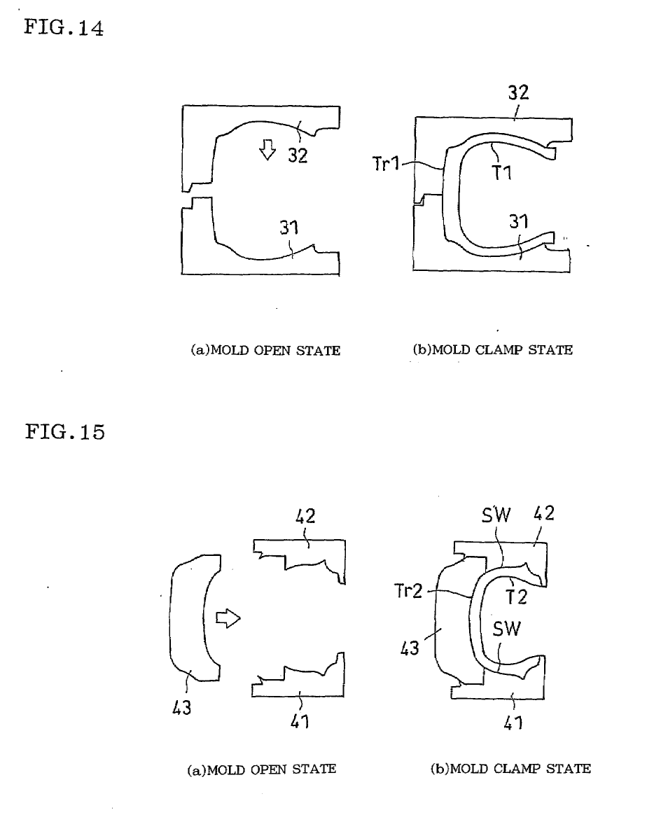

In addition, in the present embodiment, since the taper surface 51a and the taper surface 52a which are narrowed toward the inner side in the tire diametrical direction are engaged, it is possible to regulate both of a displacement (a displacement in a direction p1 or a displacement in a direction p2) in the peripheral direction of the sector 1, and an angle deviation (a deviation in a direction d1 or a direction d2) little by little in the process of the movement of the sector 1 as shown in FIG. 13. As a result, in the present embodiment, it is possible to regulate the relative positions of the sector 1 and the lower die 2 little by little at a high precision, and it is possible to suitably form the pattern design. Further, it is possible to increase a complete roundness of the sectors arranged in the peripheral direction to improve a uniformity of the formed tire.

In addition, in the present embodiment, since the taper surface 51a and the taper surface 52a become narrowed toward the outer side in the tire width direction, it is possible to smoothly fit the engagement convex portion 51 to the engagement concave portion 52. The structure mentioned above is particularly useful in the case that the engagement convex portion 51 is fitted to the engagement concave portion 52 in the process that the sector 1 is arranged in the outer side in the diametrical direction of the tread surface (refer to FIG. 7).

As a preferable dimension, there is exemplified depth of the engagement concave portion 52: 10 to 14 mm, maximum width of the bottom portion 52b: 35 to 45 mm, minimum width of the bottom portion 52b: 8 to 12 mm, angle of the taper surface 52a with respect to the bottom portion 52b: 105 to 115 degree, and protruding height or width of the engagement convex portion 51: depth or width of the engagement concave portion 52 −0.3 to −0.7 mm.

The engagement convex portion 51 in accordance with the present embodiment is integrally cast with the sector 1, and is formed, for example, by aluminum. Accordingly, it is possible to increase a durability of the engagement convex portion 51 to improve a maintenance characteristic, and to make an addition step for setting the engagement convex portion 51 in the sector 1 unnecessary.

In this case, the shapes of the engagement convex portion and the engagement concave portion are not limited to the shapes mentioned above, as far as they have the taper surface as mentioned above. For example, the shape of the engagement concave portion shown in FIG. 11 in a plan view may be formed in a triangular shape. Further, the engagement concave portion may be provided in the sector, and the engagement convex portion engaging with the engagement concave portion may be provided in the lower die.

### EXAMPLE

The engaging means constituted by the engagement convex portion and the engagement concave portion as shown in the embodiment mentioned above is provided in the tire mold for vulcanization molding the pneumatic tire having the tire size 305/40R22. A depth of the engagement concave portion is set to 12 mm, a maximum width of a bottom portion thereof is set to 40 mm, a minimum width of the bottom portion is set to 10 mm, an angle of a taper surface with respect to the bottom portion is set to 110 degree, and a working tolerance is set to ±0.2 mm. Further, a protruding height and a width of the engagement convex portion is set to dimension of the engagement concave portion −0.5 mm, and an angle of the taper surface and a working tolerance are set to the same as those of the engagement concave portion. As a result, a displacement in the peripheral direction generated in the pattern design is 0.5 mm at the maximum in the case of molding 1000 tires. As mentioned above, it is possible to prevent the displacement in the peripheral direction between the sector and the lower die, and it is possible to well form the pattern design which is continuously provided from the tread surface to the side wall portion, on the basis of the provision of the engaging means in the tire mold.

1. A tire mold for vulcanization molding a tire comprising:
a sector with which a tread surface of a tire is brought into contact, and in which a first uneven surface for forming a tread pattern is provided at the contact position;
a lower die with which a side wall portion of the tire is brought into contact, and in which a second uneven surface for forming a pattern design continuously provided with the tread pattern is provided at the contact position so as to be continuously provided with said first uneven surface in a mold clamp state;
a sector moving mechanism moving said sector in a tire width direction and a tire diametrical direction; and
engaging means for engaging with each other between said sector and said lower die which are in the mold clamp state, and positioning said sector and said lower die relatively in a peripheral direction.

2. The tire mold according to claim 1, wherein said engaging means are constituted by an engagement pin protruding to said lower die side from said sector, and a fitting groove provided in said lower die so as to extend along the tire diametrical direction and to which said engagement pin is freely fitted, and a groove width of said fitting groove being reduced little by little toward an inner side in the tire diametrical direction.

3. The tire mold according to claim 1, wherein said engaging means have an engagement convex portion provided in one of said sector and said lower die, and an engagement concave portion provided in the other of said sector and said lower die, and are structured such that said engagement convex portion and said engagement concave portion are engaged little by little by moving said sector close to said lower die along the tire diametrical direction.

4. The tire mold according to claim 3, wherein said engagement convex portion provided in said sector has a first taper surface narrowed toward an inner side in the tire diametrical direction, and said engagement concave portion provided in said lower die has a second taper surface narrowed toward the inner side in the tire diametrical direction, and said first taper surface and said second taper surface are engaged with each other in the mold clamp state.

5. The tire mold according to claim 4, wherein said engagement convex portion is integrally cast with said sector.

6. A method of vulcanization molding of a tire comprising:
spacing a sector of a tire mold comprising a first uneven surface that forms a tread pattern and an upper die of a tire mold away from a lower die of the tire mold, said lower die comprising a second uneven surface that forms a sidewall pattern;
setting a green tire to the lower die;
moving the upper die relative to the lower die such that the upper die contacts a side wall portion of the tire;
arranging the sector on the outer side of the tire in the tire diametrical direction of a tread surface of the tire;
bringing the sector into contact with the tread surface;
engaging said sector and said lower die in a mold clamp state in which the first uneven surface and the second uneven surface are connected to form a continuous pattern design.

7. The method of claim 6, wherein the engaging step comprises fitting an engagement pin that protrudes to said lower die side from said sector into a fitting groove provided in said lower die so as to extend along the tire diametrical direction, the groove wideth of said fitting groove being reduced little by little toward an inner side in the tire diametrical direction.

8. The method according to claim 6, wherein an engagement convex portion is provided in one of said sector and said lower die and an engagement concave portion is provided in the other of said sector and said lower die, and wherein the engaging step comprises engaging said concave and concave portions by little by little moving said sector close to said lower die along the tire diametrical direction.

9. The method according to claim 8, wherein said convex portion is provided in said sector and has a first taper surface narrowed toward an inner side in the tire diametrical direction and the concave portion is provided in said lower die and has a second taper surface narrowed toward the inner side in the tire diametrical direction, and wherein the engaging step comprises engaging the first taper surface to the second taper surface.

10. The method according to claim 9, wherein said engagement convex portion is integrally cast with said sector.
